(19) United States
(12) Patent Application Publication
(10) Pub. No.: US 2012/0126573 A1
(43) Pub. Date: May 24, 2012

(54) TRACTOR TRAILER FAIRING

(76) Inventor: Barry Minbiole, East Amherst, NY (US)

(21) Appl. No.: 12/952,616

(22) Filed: Nov. 23, 2010

(51) Int. Cl. B62D 35/00

(52) U.S. Cl. 296/180.2

(57) ABSTRACT

A fairing for a tractor-trailer combination to partially enclose a gap between a tractor cab connected to a chassis of a tractor and a tanker trailer having a cylindrical or oval tank. The fairing has a front section conforming to top and side surfaces of the tractor cab, a rear section having a circular element conforming to side surfaces of the cylindrical tank and a central section connecting the front section to the rear section and including an outer lateral surface having a transverse cross-section gradually transitioning between the front section to the rear section. The fairing is designed such that the rear section is sufficiently spaced from the cylindrical tank that the tanker trailer is capable of the articulated movement.

### FIELD OF THE INVENTION

The present invention relates to a tractor-trailer combination to enclose a gap between a tractor and a trailer having a cylindrical tank. More particularly, the present invention relates to such a fairing in which a front section of at least substantially rectangular configuration is connected to and conforms with the top and side surfaces of the tractor cab, a rear section of at least substantially cylindrical configuration conforms to the side surfaces of the cylindrical tank and a central section, connecting the front section to the rear section, has a transverse cross-section that gradually transitions from the front section to the rear section.

### BACKGROUND OF THE INVENTION

A large fleet of tractor trailers consumes a great deal of diesel fuel that represents a significant cost to the fleet owner. It is known that the “gap” or space between the tractor and any trailer is a significant source of drag that will adversely affect fuel economy. In case of trailers that have a tank to transport liquids, the weight distribution can present challenges. As a result, such trailers are positioned unusually far back from the tractor, exaggerating the “gap” length and the fuel economy penalty.

The prior art has long recognized the drag penalties associated with the space between the tractor and the trailer. For example, U.S. Pat. No. 4,343,505 illustrates an eddy eliminating arrangement in which a non-rigid sheet is attached, at one end, to a towed vehicle and at the other end to a trailer. U.S. Pat. No. 4,311,334 discloses a structure referred to in the patent as a “wind umbrella”. The wind umbrella is a pleated structure with hoop-like pleats to give the structure rigidity that is releasably attached to the tractor cab and a trailer. Both the tractor cab and the trailer are of rectangular configuration. Similarly, U.S. Pat. No. 3,834,752 discloses a vehicle space closing means in the form of a bag attached to the tractor cab and the trailer that can be inflated to close the gap between the tractor and the trailer. It has also been recognized that the gap need not be fully enclosed to obtain a drag-reducing benefit and further, a main contributor to drag are cross-winds entering the gap. For example U.S. Pat. No. 6,585,312 discloses an improved arrangement over prior art concepts in which cab extensions partially close off the gap by provision of a concave element connected to the tractor cab and a convex element connected front of the trailer. The purpose of this is to create a low pressure field at the front of the trailer and a high pressure field at the rear of the cab in response to cross-winds entering the gap between tractor and trailer and thereby reduce drag from cross winds.

In summary then, all of these patents are designed to reduce the space between the tractor and the trailer and thereby reduce drag on the tractor trailer combination at speed. A problem in such prior art, however, is that when the gap between tractor and trailer is fully sealed, then it becomes difficult to access and inspect equipment behind the tractor cab. A further problem with some of the prior-art arrangements is that they add weight to the tractor-trailer combination. Weight is an important consideration in that the heavier the device sealing the gap, the less cargo that can be carried due to weight restrictions placed on over the road tractor-trailers. For example, the use of an inflatable bag can require separate compression equipment to inflate the bag. Although exhaust gases can be used for such purposes, the result is a hazardous environment is created within the enclosed space. A yet further problem is that when flexible sheet-like coverings are used, while such coverings will allow for some degree of articulation of the trailer during turns, the material making up such a covering will suffer wear and tear due to the air impacting the covering at speed and therefore, a reduction in durability as compared with more rigid structures. Moreover at speed, such coverings can sag to reduce the aerodynamic benefit of the covering. None of the prior art patents address a tractor trailer combination in which the tractor cab is rectangular and the trailer mounts a cylindrical tank. In such case, it is not apparent as to how the prior art discussed above could be modified to reduce the gap in such an arrangement

As will be discussed, the present invention provides a fairing that is specifically designed to partially close off a gap between a tractor cab and a trailer mounting a tank that among other advantages can incorporate light-weight construction and a design that will allow for rapid access to the rear of the tractor cab and equipment housed in such area. Moreover, the present invention is particularly adapted to use flexible sheet-like coverings, but in a manner that provides a more rigid surface than prior art designs.

### SUMMARY OF THE INVENTION

The present invention provides a fairing for a tractor-trailer combination to partially enclose a gap between a tractor cab connected to a chassis of a tractor and a tanker trailer having at least a substantially cylindrical tank. The tanker trailer is pivotably mounted to the chassis such that the tanker trailer is capable of articulated movement with respect to the tractor during turns of the tractor-trailer combination.

The fairing has a front section, a rear section and a central section. The front section is of at least substantially rectangular configuration and conforms to top and side surfaces of the tractor cab. The rear section has a circular element of at least substantially circular configuration located opposite to the cylindrical tank and sized to conform to side surfaces of the cylindrical tank. The central section connects the front section to the rear section and thereby forms with the front section and the rear section a fairing structure. The central section includes an outer lateral surface having a transverse cross-section gradually transitioning between the at least substantially rectangular configuration of the front section to the at least substantially circular configuration of the circular element of the rear section. The fairing structure is sized such that, when positioned in the gap, the rear section is sufficiently spaced from the cylindrical tank that the tanker trailer is capable of the articulated movement and the front section is located adjacent to a back surface of the tractor cab located opposite to the tanker trailer. A means is provided for mounting the fairing structure to the tractor.

It is appropriate to point out here that the term “at least substantially cylindrical” when used in connection with the trail tank and as used herein and in the claims means either a cylinder having a circular transverse cross-section or an oval transverse cross-section. Both of such configurations are commonly utilized in tanker trailers. Similarly, the term “at least substantially circular” when used in connection with the rear section and as used herein and in the claims means either a circle or an oval to conform to the transverse-cross-section of the tank. Lastly, the term “at least substantially rectangular” when used in connection with the tractor cab and as used herein and in the claims means either a rectangular transverse cross-section or one in which the corners are slightly rounded. Both of such configurations are commonly seen in tractor cab designs.

The central section can be configured to allow access to equipment of the tractor-trailer combination situated at the rear region of the tractor cab and the chassis. In this regard, the central section can comprise elongated stiffeners connecting the front section to the rear section.

The rear section can have two spaced apart leg-like elements depending, at one end, from the circular element and sized such that the other end of the leg-like elements contacts the chassis. The transverse cross-section of the outer lateral surface also gradually transitions between the at least substantially rectangular configuration of the front section to the two spaced apart leg-like elements. The outer lateral surface of the central section can be a flexible sheet-like covering stretched across the stiffeners and connected to the front section and the rear section. In this regard, the front section can be formed of an extrusion each having a lengthwise extending slot and an elongated anchoring member configured to extend through the slot and hold the flexible sheet-like covering, at one edge of the flexible sheet-like covering, within the slot. The opposite edge of the flexible sheet-like covering is affixed to the rear section.

The front section can be configured such that the front section contacts the top and side surfaces of the tractor cab. In such case, the fairing mounting means comprises means for connecting the front section to the tractor cab and means for connecting the other end of the leg-like elements to the chassis. The front section connection means can comprise an adhesive and the rear section connecting means can comprise threaded connectors affixing the other end of the leg-like elements to the chassis.

The tractor can have an exhaust pipe extending through the gap between the tractor cab and the tanker trailer and the flexible sheet-like covering is provided with has a reinforced opening through which the exhaust pipe extends. The reinforced opening comprises a ring-like element connected to the flexible sheet-like covering and a set of spring-like elements connecting the exhaust pipe to the ring-like element to hold the flexible sheet-like covering in place.

### BRIEF DESCRIPTION OF THE DRAWINGS

While the specification concludes with claims distinctly pointing out the subject matter that Applicant regards as his invention, it is believed that the invention will be better understood when taken in connection with the accompanying drawings in which:

FIG. 1 is a perspective view of a tractor-trailer combination incorporating a fairing of the present invention;

FIG. 2 is a side elevational view of FIG. 1 with a flexible sheet-like covering removed from the fairing to illustrate the structure that supports the flexible sheet-like covering covering;

FIG. 3 is a perspective view of FIG. 1 with a flexible sheet-like covering removed from the fairing to illustrate the structure that supports the flexible sheet-like covering covering;

FIG. 4 is a rear elevational view of FIG. 2;

FIG. 5 is a sectional view of the front section of the fairing incorporating an extrusion designed to releasably retain the flexible sheet-like covering; and

FIG. 6 is a sectional view of the rear section of the fairing illustrating the attachment of the flexible sheet-like covering and a flexible strip to the fairing structure.

### DETAILED DESCRIPTION

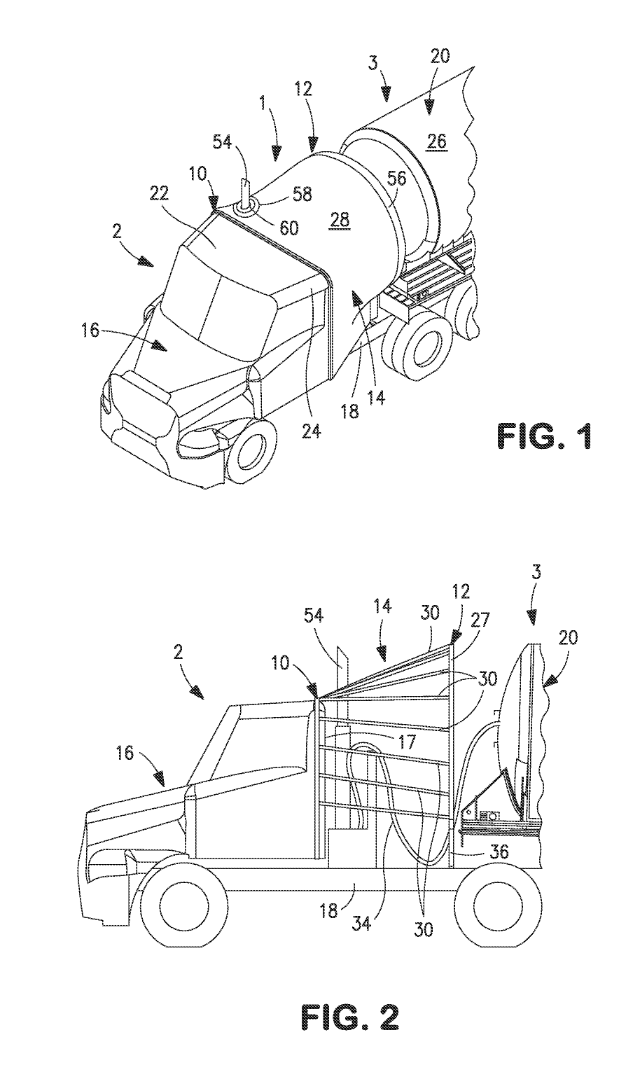

With reference to FIG. 1, a fairing 1 in accordance with the present invention is illustrated that is connected to a tractor 2 to reduce a gap or opening between the tractor 2 and a trailer 3. Fairing 1 has a front section 10, a rear section 12 and a central section 14 connecting the front section 10 to the rear section 12 to thereby form the fairing structure. Tractor 2 has a cab 16 mounted on a chassis 18 and trailer 3 has a tank 20 of cylindrical configuration.

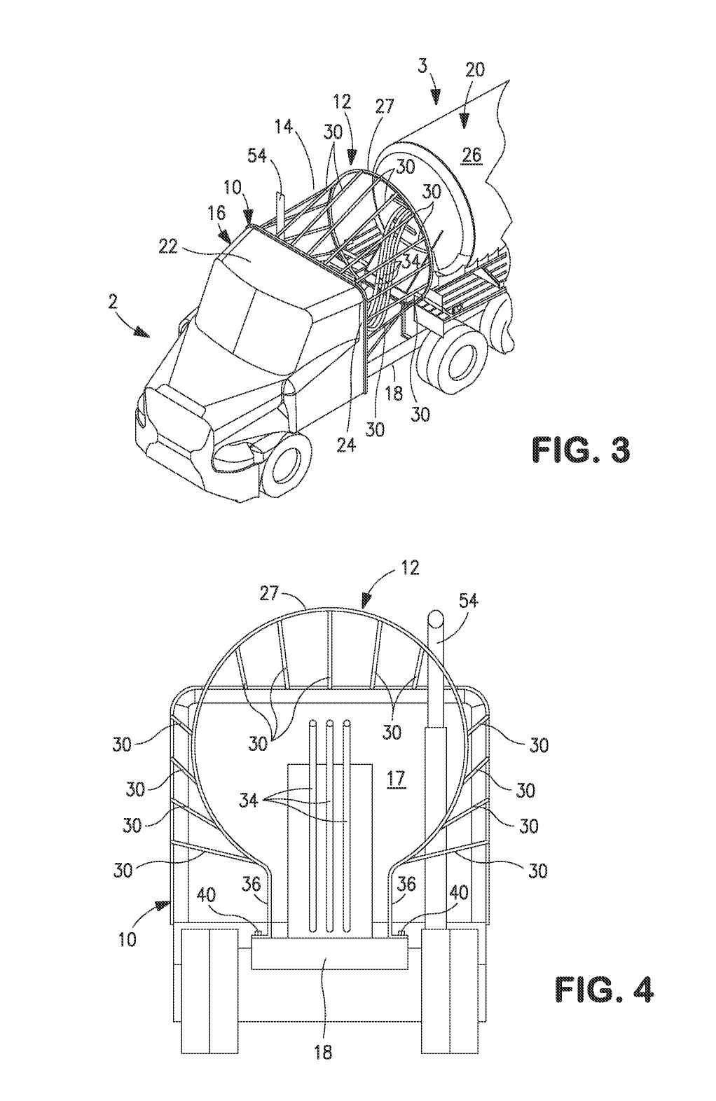

With further reference to FIGS. 2 and 3, the front section 10 conforms to the top and side surfaces 22 and 24 of the tractor cab 16 and as will be discussed is formed from an extrusion 42 that is designed to retain a flexible sheet-like covering 26 that will also be discussed in more detail hereinafter. As illustrated, the top and side surfaces 22 and 24 are substantially rectangular in that there are slightly curves surfaces at the juncture of the top and side surfaces 22 and 24. As could be appreciated, the top and side surfaces 22 could be of rectangular configuration, depending on the design of the tractor cab. Although the front section 10 is illustrated as being positioned against the top and side surfaces 22 and 24 adjacent to a rear surface 17 of the tractor cab 17, a fairing of the present invention could be designed such that the front section 10 is positioned against the rear surface 17.

With further reference to FIG. 4, the rear section 12 has an element 27 of circular configuration that is located opposite to the tank 20 and is configured to conform to the side surfaces 26 presented by the circular transverse cross-section of the tank 20. As can be appreciated, certain tanks are of oval configuration and in such case, the rear section 12 would also be in the form of a conforming oval.

The central section 14 gradually transitions between the substantially rectangular front section 12 and the element 27 of rear section 12. Specifically, there is a gradual transition between the rectangular configuration of the front section 10 to the circular configuration of the element 27. The outer lateral surface of the central section 14 is formed by a flexible sheet-like covering 28 that is stretched across stiffeners 30 connecting the front section 10 to the rear section 14. Flexible sheet-like covering 28 can be chosen from among a group including conventional tarp materials, fabrics designed for tension applications, etc. It is possible that the center section could be a flexible covering retained simply by the tension on front and rear sections. It is to be noted that other configurations for the central section 14 are possible. For example, central section 14 could be a reinforced or unreinforced polymeric molded component. Even in such case, stiffeners 30 could be molded into such structure for added strength. Also, in place of a flexible sheet-like covering 28, fiberglass panels could be used that would be attached to the stiffeners 30. Although the present invention contemplates structures that are not as open as the illustrated embodiment, an advantage of the illustrated embodiment is that access is allowed for inspection of such components such as pneumatic hoses 34 extending from the tractor 2 to the trailer 3.

The fairing 1 is sized such that when positioned in the gap and on the chassis 18, the rear section 12 and therefore, the circular element 27 thereof, is sufficiently spaced from the tank 20 that the tanker trailer is capable of the articulated movement and the front section 10 is located adjacent to a back surface 17 of the tractor cab 16, either against the top and side surfaces 22 and 24 or against the back surface 17. In the illustrated embodiment, the front section 10 is connected to the top and side surfaces 22 and 24. The rear section 12 is provided with legs 36, at one end, depending from the circular element 27 and at the other end are positioned against the chassis 18. The fairing 1 is connected to the chassis 18 by bolts 40 or other threaded connectors affixing the legs 36 to the chassis. The flexible sheet-like covering 28 is also connected to the legs 36 and therefore, also the transverse cross-section of the fairing 1 also gradually transitions from the rectangular configuration of the front section 10 to the lets 36. As can be appreciated, there are other possible means of connecting the fairing 1 to the tractor 2. For example, the legs 36 could depend from the central section 14 or the stiffeners 30 could be designed to contact the chassis 18 to be held in place by bolts. This would be attractive if it were not desired to physically connect the front section 10 to the tractor cab 16.

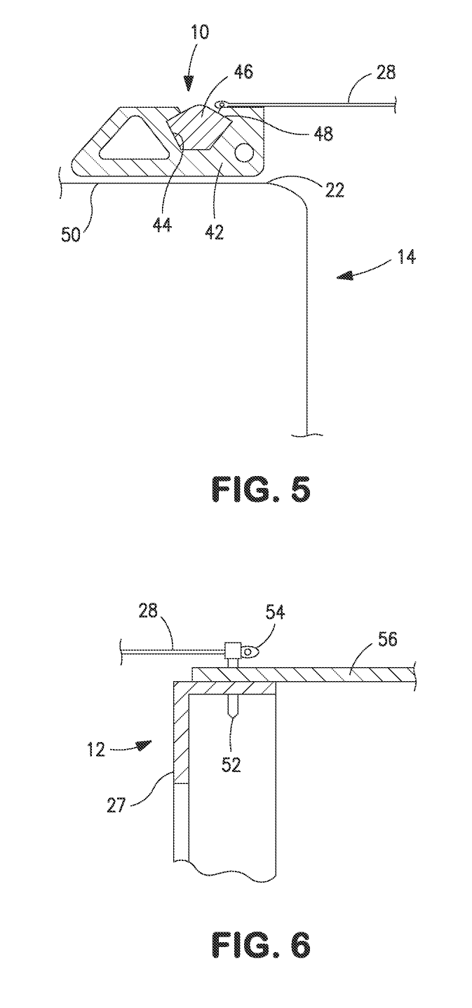

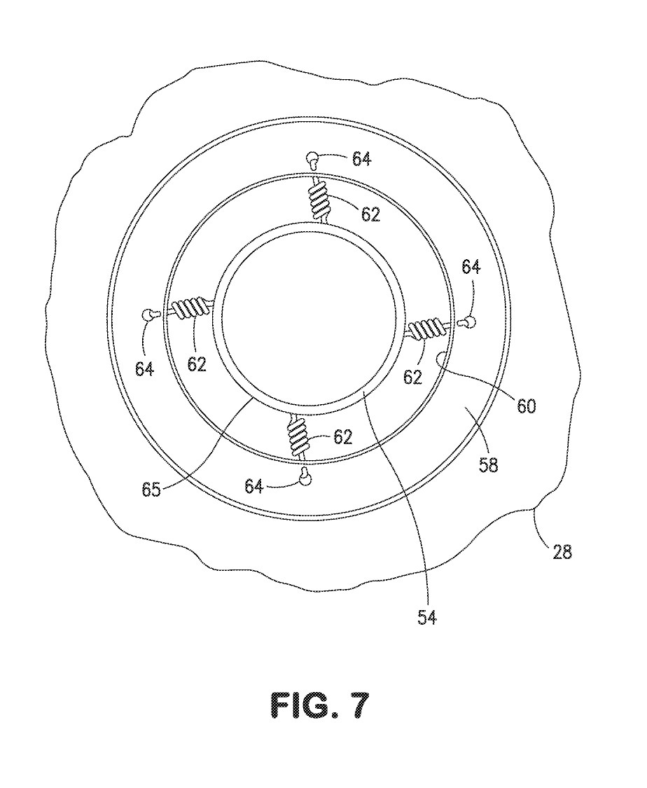

With reference to FIG. 5, the front section 10 is preferably formed by an extrusion 42 having a length-wise extending slot 44 and an elongated anchoring member 46 that is in the form of a bar or a series of bars. The edge 48 of the flexible sheet-like covering 28 is positioned within the slot 44 and then held in place by the anchoring member 46. The extrusion 42 can be attached to the tractor cab 16 by means of an adhesive 50 and also possibly self-threading screws or screws alone. In the section illustrated, the extrusion is connected to the top surface 22 of the tractor cab 16 by means of adhesive 50 that would also be applied to the sides 24 of the tractor cab 16 to hold the front section 10 in place. Although the same arrangement can be used in connection with the rear element 12, preferably the flexible sheet-like covering 28, as illustrated in FIG. 6, the circular element 27 and the legs 36 are formed of an angle section and the flexible sheet-like covering 27 is simply held in place by self-treading screws 52. A lip 54 is form along one edge of the flexible sheet-like covering 28 for reinforcing purposes. In practice then, the flexible sheet-like covering 28 is first attached to the circular element 27 and legs 36 and then stretched across the stiffeners 30 to be held in place within the extrusion 42.

Optionally, the screws 52 can hold a resilient strip 56 that will further close the gap between the tractor cab 16 and the tank 3. While the spacing between the front section 10 and the rear section 13 should be sized to allow for complete articulation of the trailer 3 with respect to the tractor 2 during tight turns, the resilient strip 56 will deform if the tank 20 contacts the strip 56 during such tight turns.

With reference to FIG. 7, preferably, an opening is provided within the flexible sheet-like covering 28 to accommodate an exhaust stack 54. Although a simple opening in the flexible sheet-like covering 28 could be provided for such purposes, preferably a reinforcing ring 58 is attached to the flexible sheet-like covering 28 to form an opening 60. Reinforcing ring 58 can be made of non-corroding metal and is affixed to the flexible sheet-like covering by fasteners or adhesive. The reinforcing ring is then connected to the exhaust stack 54 by spring-like elements 62 that simply hook into openings 64 provided in the reinforcing ring 58 and into openings provided in a ring around the exhaust stack 54. The purpose of this is to hold the flexible sheet-like covering 28 in place in response to turbulent air flow produced by the air passing over the opening 60 and to isolate the flexible sheet-like covering 28 from the heat of the exhaust pipe.

While the present invention has been described in reference to a preferred embodiment, as will occur to those skilled in the art, numerous additions, changes and omissions can be made to such embodiment without departing from the spirit and scope of the present invention as set forth in the appended claims.

I claim:

1. A fairing for a tractor-trailer combination to partially enclose a gap between a tractor cab connected to a chassis of a tractor and a tanker trailer having a substantially cylindrical tank and pivotably mounted to the chassis such that the tanker trailer is capable of articulated movement with respect to the tractor during turns of the tractor-trailer combination, said fairing comprising:
a front section of at least substantially rectangular configuration conforming to top and side surfaces of the tractor cab;
a rear section having a circular element of at least substantially circular configuration sized to conform to side surfaces of the cylindrical tank and located opposite to the cylindrical tank;
a central section connecting the front section to the rear section and thereby forming with the front section and the rear section a fairing structure, the central section including an outer lateral surface having a transverse cross-section gradually transitioning between the at least substantially rectangular configuration of the front section to the at least substantially circular configuration of the circular element of the rear section;
the fairing structure sized such that, when positioned in the gap, the rear section is sufficiently spaced from the cylindrical tank that the tanker trailer is capable of the articulated movement and the front section is located adjacent to a back surface of the tractor cab located opposite to the tanker trailer; and
means for mounting the fairing structure to the tractor.

2. The fairing of claim 1, wherein the central section is configured to allow access to equipment of the tractor-trailer combination situated at the rear region of the tractor cab and the chassis.

3. The fairing of claim 2, wherein the central section comprises elongated stiffeners connecting the front section to the rear section.

4. The fairing of claim 1, wherein:
the rear section has two spaced apart leg-like elements depending, at one end, from the circular element and sized such that the other end of the leg-like elements contact the chassis; and
the transverse cross-section of the outer lateral surface also gradually transitions between the at least substantially rectangular configuration of the front section to the two spaced apart leg-like elements.

5. The fairing of claim 4, wherein:
the central section comprises elongated stiffeners connecting the front section to the rear section; and
the outer lateral surface is a flexible sheet-like covering stretched across the stiffeners and connected to the front section and the rear section.

6. The fairing of claim 5, wherein:
the front section is formed of an extrusion each having a lengthwise extending slot and an elongated anchoring member configured to extend through the slot and hold the flexible sheet-like covering, at one edge of the flexible sheet-like covering, within the slot; and
the opposite edge of the flexible sheet-like covering is affixed to the rear section.

7. The fairing of claim 6, wherein:
the front section is configured such that the front section contacts the top and side surfaces of the tractor cab;
the fairing mounting means comprises means for connecting the front section to the tractor cab and means for connecting the other end of the leg-like elements to the chassis.

8. The fairing of claim 7, wherein the front section connection means comprises an adhesive and the rear section connecting means comprises threaded connectors affixing the other end of the leg-like elements to the chassis.

9. The fairing of claim 5, wherein:
the tractor has an exhaust pipe extending through the gap between the tractor cab and the tanker trailer; and
the flexible sheet-like covering has a reinforced opening through which the exhaust pipe extends; and
the reinforced opening comprises a ring-like element connected to the flexible sheet-like covering and a set of spring-like elements connecting the exhaust pipe to the ring-like element to hold the flexible sheet-like covering in place.

10. The fairing of claim 8, wherein:
the tractor has an exhaust pipe extending through the gap between the tractor cab and the tanker trailer; and
the flexible sheet-like covering has a reinforced opening through which the exhaust pipe extends; and
the reinforced opening comprises a ring-like element connected to the flexible sheet-like covering and a set of spring-like elements connecting the exhaust pipe to the ring-like element to hold the flexible sheet-like covering in place.
